(19) United States
(12) Patent Application Publication
(10) Pub. No.: US 2014/0146001 A1
(43) Pub. Date: May 29, 2014

(54) Electronic Apparatus and Handwritten Document Processing Method

(71) Applicant: KABUSHIKI KAISHA TOSHIBA, Tokyo (JP)

(72) Inventor: Kunio Baba, Ome-shi (JP)

(73) Assignee: KABUSHIKI KAISHA TOSHIBA, Tokyo (JP)

(21) Appl. No.: 13/763,588

(22) Filed: Feb. 8, 2013

(30) Foreign Application Priority Data
Nov. 28, 2012 (JP) 2012-260080

(51) Int. Cl. G06F 3/044

(52) U.S. Cl. CPC G06F 3/044
USPC 345/174

(57) ABSTRACT

According to one embodiment, an electronic apparatus includes a processor and a setting module. The processor displays, if a first stroke is handwriting-input on a screen and the electronic apparatus is in a first mode, a locus of the first stroke on the screen. The processor executes, if the first stroke is handwriting-input on the screen and the electronic apparatus is in a second mode, first processing based on the first stroke. The setting module sets the electronic apparatus in the second mode if a period for which a position of a handwriting-input position is in a first range is or longer than a first period.

### CROSS-REFERENCE TO RELATED APPLICATIONS

This application is based upon and claims the benefit of priority from Japanese Patent Application No. 2012-260080, filed Nov. 28, 2012, the entire contents of which are incorporated herein by reference.

### FIELD

Embodiments described herein relate generally to processing of a handwritten document.

### BACKGROUND

In recent years, various electronic apparatuses such as tablets, PDAs, and smartphones have been developed. Most of electronic apparatuses of this type include touch screen displays to facilitate user's input operations.

When the user touches a menu or object displayed on the touch screen display with the finger or the like, he or she can instruct the electronic apparatus to execute a function associated with the touched menu or object.

Some of such electronic apparatuses have a function of allowing the user to handwrite characters, figures, and the like on the touch screen display. A handwritten document (handwritten page) including such handwritten characters and figures is stored, and is browsed as needed.

On a handwritten document, not only handwritten characters and figures but also various objects which express, for example, lines and figures can be displayed. In addition, descriptions displayed on a handwritten document can be erased. The user switches the electronic apparatus from a handwriting mode to one of various modes such as an object drawing mode and a mode for erasing handwritten descriptions, thus instructing desired processing.

However, such mode switching may often be troublesome for the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is a view showing an example of a handwritten document to be processed by the electronic apparatus of the embodiment.

FIG. 3 is an exemplary view for explaining time-series information corresponds to the handwritten document shown in FIG. 2, the time series information being stored in a storage medium by the electronic apparatus of the embodiment.

FIG. 4 is an exemplary block diagram showing the system configuration of the electronic apparatus of the embodiment.

FIG. 5 is an exemplary block diagram showing the functional configuration of a digital notebook application program executed by the electronic apparatus of the embodiment.

FIG. 6 is a view for explaining a drawing example of a line on a handwritten document processed by the electronic apparatus of the embodiment.

FIG. 7 is a view for explaining a drawing example of a circle on a handwritten document processed by the electronic apparatus of the embodiment.

FIG. 8 is a view for explaining a drawing example of a rectangle on a handwritten document processed by the electronic apparatus of the embodiment.

FIG. 9 is a view for explaining an erasing example of a stroke on a handwritten document processed by the electronic apparatus of the embodiment.

FIG. 10 is a view for explaining a drawing example of a line based on a grid on a handwritten document processed by the electronic apparatus of the embodiment.

FIG. 11 shows a configuration example of figure object information used by the electronic apparatus of the embodiment.

FIG. 12 is a flowchart showing an example of the procedure of handwriting input processing executed by the electronic apparatus of the embodiment.

### DETAILED DESCRIPTION

Various embodiments will be described hereinafter with reference to the accompanying drawings.

In general, according to one embodiment, an electronic apparatus includes a processor and a setting module. The processor is configured to display, if a first stroke is handwriting-input on a screen and the electronic apparatus is in a first mode, a locus of the first stroke on the screen. The processor is configured to execute, if the first stroke is handwriting-input on the screen and the electronic apparatus is in a second mode, first processing based on the first stroke. The setting module is configured to set the electronic apparatus in the second mode if a period for which a position of a handwriting-input is in a first range is longer than a first period.

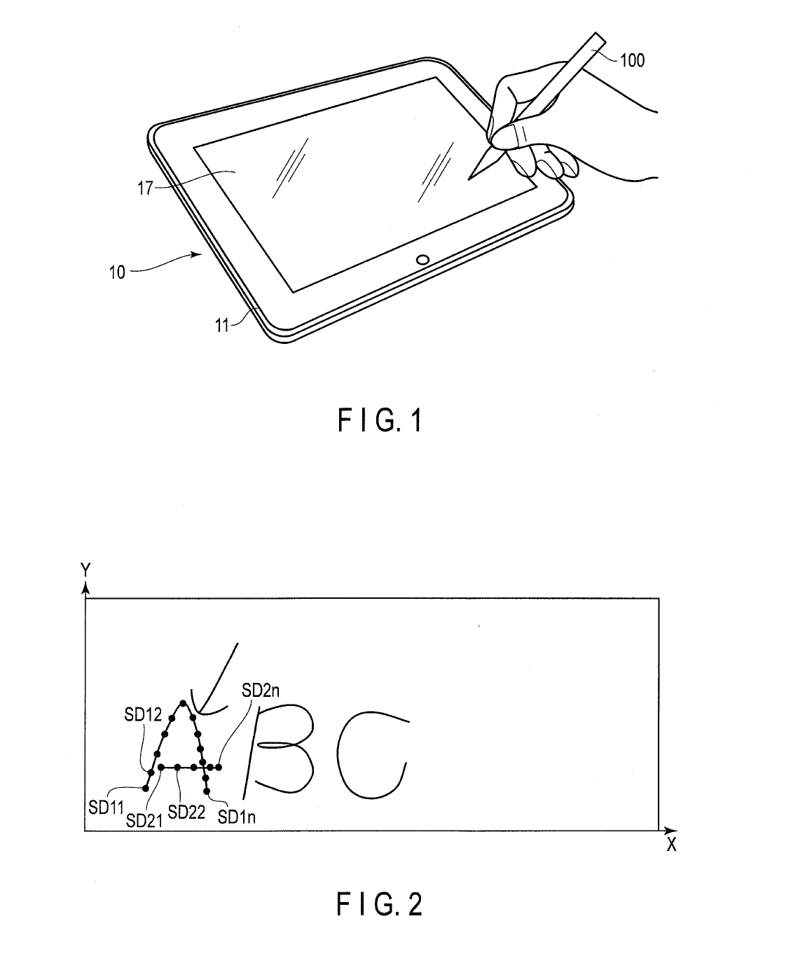

FIG. 1 is a perspective view showing the external appearance of an electronic apparatus according to one embodiment. This electronic apparatus is, for example, a pen-based portable electronic apparatus which allows a handwriting input using a pen or the finger. This electronic apparatus can be implemented as a tablet computer, notebook-type personal computer, smartphone, PDA, and the like. The following description will be given under the assumption that this electronic apparatus is implemented as a tablet computer 10. The tablet computer 10 is a portable electronic apparatus which is also called a tablet or slate computer, and includes a main body 11 and touch screen display 17, as shown in FIG. 1. The touch screen display 17 is attached to be overlaid on the upper surface of the main body 11.

The main body 11 has a thin box-shaped housing. The touch panel screen 17 incorporates a flat panel display and a sensor which is configured to detect a touch position of a pen or finger on the screen of the flat panel display. The flat panel display may be, for example, a liquid crystal display (LCD). As the sensor, for example, a touch panel of a capacitance type, a digitizer of an electromagnetic induction type, or the like can be used. The following description will be given under the assumption that both the two types of sensors, that is, the digitizer and touch panel are incorporated in the touch screen display 17.

Each of the digitizer and touch panel is arranged to cover the screen of the flat panel display. This touch screen display 17 can detect not only a touch operation on the screen using the finger but also that on the screen using a pen 100. The pen 100 may be, for example, an electromagnetic induction pen.

The user can make a handwriting input operation for inputting a plurality of strokes by handwriting on the touch screen display 17 using an external object (pen 100 or finger). During the handwriting input operation, a locus of movement of the external object (pen 100 or finger), that is, a locus (handwriting) of a stroke handwritten by the handwriting input operation on the screen is drawn in real-time, thereby displaying the locus of each stroke on the screen. The locus of the movement of the external object while the external object is in contact with the screen corresponds to one stroke. Sets of a large number of strokes corresponding to a handwritten character or figure, that is, a number of sets of loci (handwriting) configure a handwritten document.

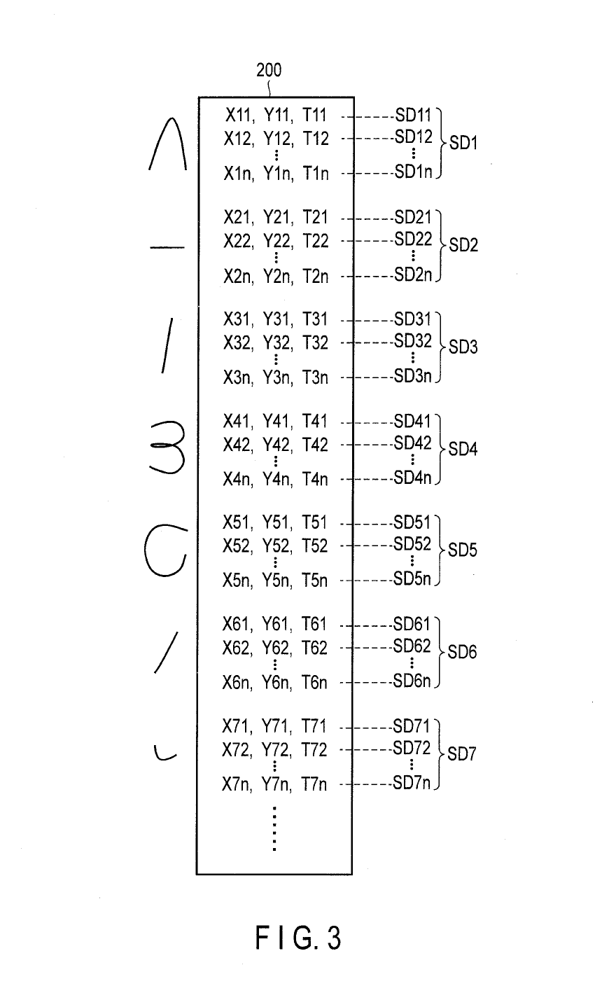

In this embodiment, this handwritten document is stored in a storage medium not as image data but as handwritten document data including coordinate sequences of loci of respective strokes and time-series information indicative of an order relation between strokes. Details of this time-series information will be described in detail later with reference to FIG. 3. This time-series information generally means a set of time-series stroke data corresponding to a plurality of strokes. Each stroke data is not particularly limited as long as it is data that can express one stroke which can be input by handwriting, and for example, includes a coordinate data sequence (time-series coordinates) corresponding to respective points on a locus of this stroke. An arrangement order of these stroke data corresponds to a handwriting order of respective strokes, that is, a stroke order.

The user can further instruct to execute first processing based on strokes by the aforementioned handwriting input operation. To this first processing, for example, processing for drawing a figure object (for example, a line, circle, rectangle, or the like) based on strokes on a handwritten document, processing of “eraser” for erasing a stroke corresponding to a newly handwritten input stroke from a plurality of already drawn strokes, and the like are assigned.

When the user wants to execute this first processing, he or she brings the external object into contact with the screen, and stops it at that position temporarily (for example, for a threshold time period or longer). That is, the user long-presses one point on the screen. Note that with this user operation, after the user brings the external object into contact with the screen, he or she can hardly stop it at that position (coordinates) without causing a displacement of several pixels. For this reason, in this embodiment, when the contact position of the external object falls within a first range (for example, within several pixels), it is determined that the external object is stopped at that position.

Next, the user handwrites a stroke without releasing the external object from the screen. For example, when the processing for drawing a figure object is assigned to the first processing, the user handwrites a stroke indicative of a shape (approximate shape) of a figure object. Thus, the figure object based on the handwritten stroke is displayed on the screen. Figure object data indicative of this figure object can be included in the aforementioned handwritten document data.

In this embodiment, as described above, by detecting the operation for bringing the external object into contact with the screen, and stopping it at that position, the control transits from a first mode (free drawing mode) to a second mode. In the first mode, a locus of a handwritten stroke is displayed. In the second mode, the first processing based on a stroke (for example, to display a figure object based on a stroke) is executed. Then, after the first processing based on one stroke is executed in the second mode, the control returns to the first mode. Thus, the first and second modes can be switched during a handwriting input operation without making any operation required to switch the mode using a button in a tool, menu, or the like.

The tablet computer 10 can read existing arbitrary handwritten document from the storage medium, and can display, on the screen, a handwritten document corresponding to this handwritten document data. That is, the tablet computer 10 can display a handwritten document on which loci of a plurality of strokes indicated by time-series information are drawn, and a figure object indicated by figure object data is drawn.

The relationship between strokes (a character, mark, symbol, figure, table, and the like) handwritten by the user and the time-series information will be described below with reference to FIGS. 2 and 3. FIG. 2 shows an example of a handwritten document (handwritten character string) handwritten on the touch screen display 17 using the pen 100 or the like.

In a handwritten document, still another character, figure, or the like is handwritten above already handwritten characters, figures, or the like. FIG. 2 assumes a case in which a handwritten character string “ABC” is handwritten in an order of “A”, “B”, and “C”, and a handwritten arrow is then handwritten in the vicinity of a handwritten character “A”.

The handwritten character “A” is expressed by two strokes (a locus of a “A” shape and that of a “−” shape) handwritten using the pen 100 or the like, that is, two loci. The “Λ”-shaped locus of the pen 100, which is handwritten first, is sampled in real-time at, for example, equal time intervals, thereby obtaining time-series coordinates SD11, SD12, . . . , SD1n of the “Λ”-shaped stroke. Likewise, the “−”-shaped locus of the pen 100, which is handwritten next, is sampled, thereby obtaining time-series coordinates SD21, SD22, . . . , SD2n of a “−”-shaped stroke.

The handwritten character “B” is expressed by two strokes handwritten using the pen 100 or the like, that is, two loci. The handwritten character “C” is expressed by one stroke handwritten using the pen 100 or the like, that is, one locus. The handwritten “arrow” is expressed by two strokes handwritten using the pen 100 or the like, that is, two loci.

FIG. 3 shows time-series information 200 corresponding to the handwritten document shown in FIG. 2. The time-series information 200 includes a plurality of stroke data SD1, SD2, . . . , SD7. In the time-series information 200, these stroke data SD1, SD2, . . . , SD7 are time-serially arranged in a stroke order, that is, a handwritten order of a plurality of strokes.

In the time-series information 200, the first and second stroke data SD1 and SD2 respectively indicate two strokes of the handwritten character “A”. The third and fourth stroke data SD3 and SD4 respectively indicate two strokes of the handwritten character “B”. The fifth stroke data SD5 indicates one stroke of the handwritten character “C”. The sixth and seventh stroke data SD6 and SD7 respectively indicate two strokes of the handwritten arrow.

Each stroke data includes a coordinate data sequence (time-series coordinates) corresponding to one stroke, that is, a plurality of coordinates corresponding to a plurality of points on a locus of one stroke. In each stroke data, the plurality of coordinates are time-serially arranged in an order that stroke was written. For example, as for the handwritten character “A”, the stroke data SD1 includes a coordinate data sequence (time-series coordinates) corresponding to respective points on the locus of the “Λ”-shaped stroke of the handwritten character “A”, that is, n coordinate data SD11, SD12, . . . , SD1n. The stroke data SD2 includes a coordinate data sequence corresponding to respective points on the locus of the “−”-shaped stroke of the handwritten character “A”, that is, n coordinate data SD21, SD22, . . . , SD2n. Note that the number of coordinate data may be different for each stroke data.

Each coordinate data indicates X and Y coordinates corresponding to one point in the corresponding locus. For example, the coordinate data SD11 indicates an X coordinate (X11) and Y coordinate (Y11) of a start point of the “Λ”-shaped stroke. Also, the coordinate data SD1n indicates an X coordinate (X1n) and Y coordinate (Y1n) of an end point of the “Λ”-shaped stroke.

Furthermore, each coordinate data may include time-stamp information T indicative of a handwritten timing of a point corresponding to that coordinate data. The handwritten timing may be either an absolute time (for example, year, month, day, hour, minute, second) or a relative time with reference to a certain timing. For example, an absolute time (for example, year, month, day, hour, minute, second) at which a stroke began to be written may be added to each stroke data as time-stamp information, and a relative time indicative of a difference from the absolute time may be added to each coordinate data in that stroke data as the time-stamp information T.

In this way, using the time-series information in which the time-stamp information T is added to each coordinate data, the temporal relationship between strokes can be precisely expressed.

Information (Z) indicative of a writing pressure may be added to each coordinate data.

Furthermore, in this embodiment, since a handwritten document is stored as the time-series information 200 including sets of time-series stroke data in place of an image or character recognition results, as described above, handwritten characters and figures can be handled independently of languages. Hence, the structure of the time-series information 200 of this embodiment can be commonly used in various countries using different languages around the world.

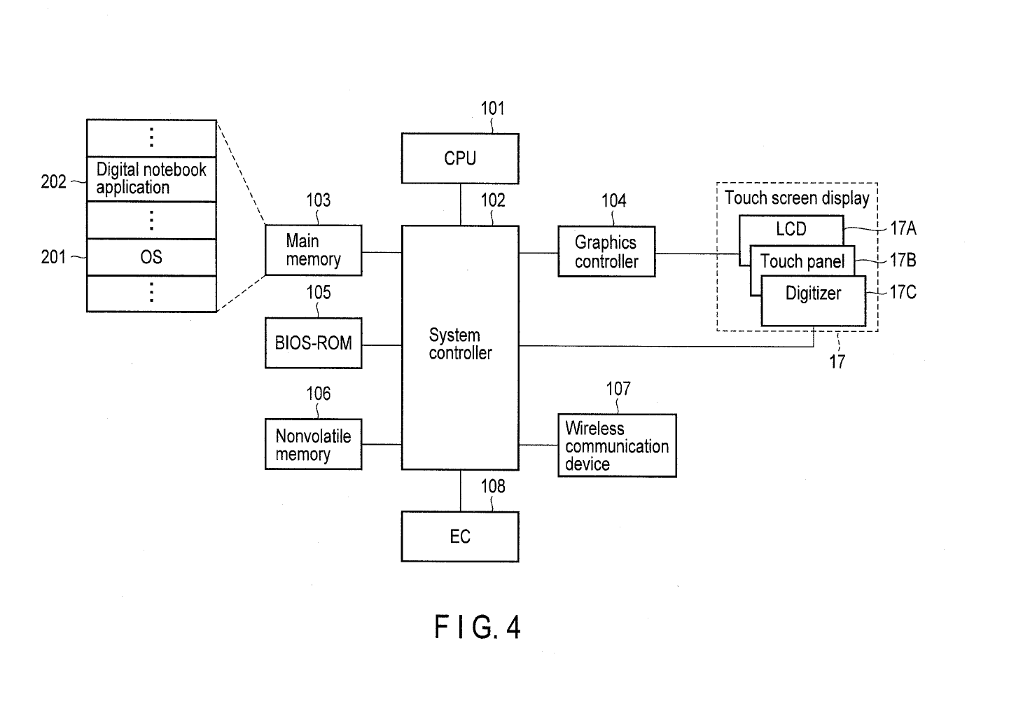

FIG. 4 shows the system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, an embedded controller (EC) 108, and the like.

The CPU 101 is a processor, which controls operations of various components in the tablet computer 10. The CPU 101 executes various software programs that are loaded from the nonvolatile memory 106 as a storage device onto the main memory 103. These software programs include an operating system (OS) 201 and various application programs. The application programs include a digital notebook application program 202. This digital notebook application program 202 has a function of creating and displaying the aforementioned handwritten document, and the like.

The CPU 101 also executes a basic input/output system (BIOS) stored in the BIOS-ROM 105. The BIOS is a program required for hardware control.

The system controller 102 is a device which connects a local bus of the CPU 101 and various components. The system controller 102 also incorporates a memory controller that controls accesses to the main memory 103. The system controller 102 also has a function of executing communications with the graphics controller 104 via, for example, a PCI EXPRESS serial bus.

The graphics controller 104 is a display controller which controls an LCD 17A used as a display monitor of this tablet computer 10. A display signal generated by this graphics controller 104 is sent to the LCD 17A. The LCD 17A displays a screen image based on the display signal. On this LCD 17A, a touch panel 17B and digitizer 17C are arranged. The touch panel 17B is a capacitance type pointing device used to allow the user to make an input on the screen of the LCD 17A. The touch panel 17B detects a touch position of the finger on the screen, a movement of the touch position, and the like. The digitizer 17C is an electromagnetic induction type pointing device used to allow the user to make an input on the screen of the LCD 17A. The digitizer 17C detects a touch position of the pen 100 on the screen, a movement of the touch position, and the like.

The wireless communication device 107 is a device configured to execute wireless communications such as wireless LAN or 3G mobile communications. The EC 108 is a one-chip microcomputer including an embedded controller required for power management. The EC 108 has a function of turning on/off the power supply of this tablet computer 10 in response to an operation of a power button by the user.

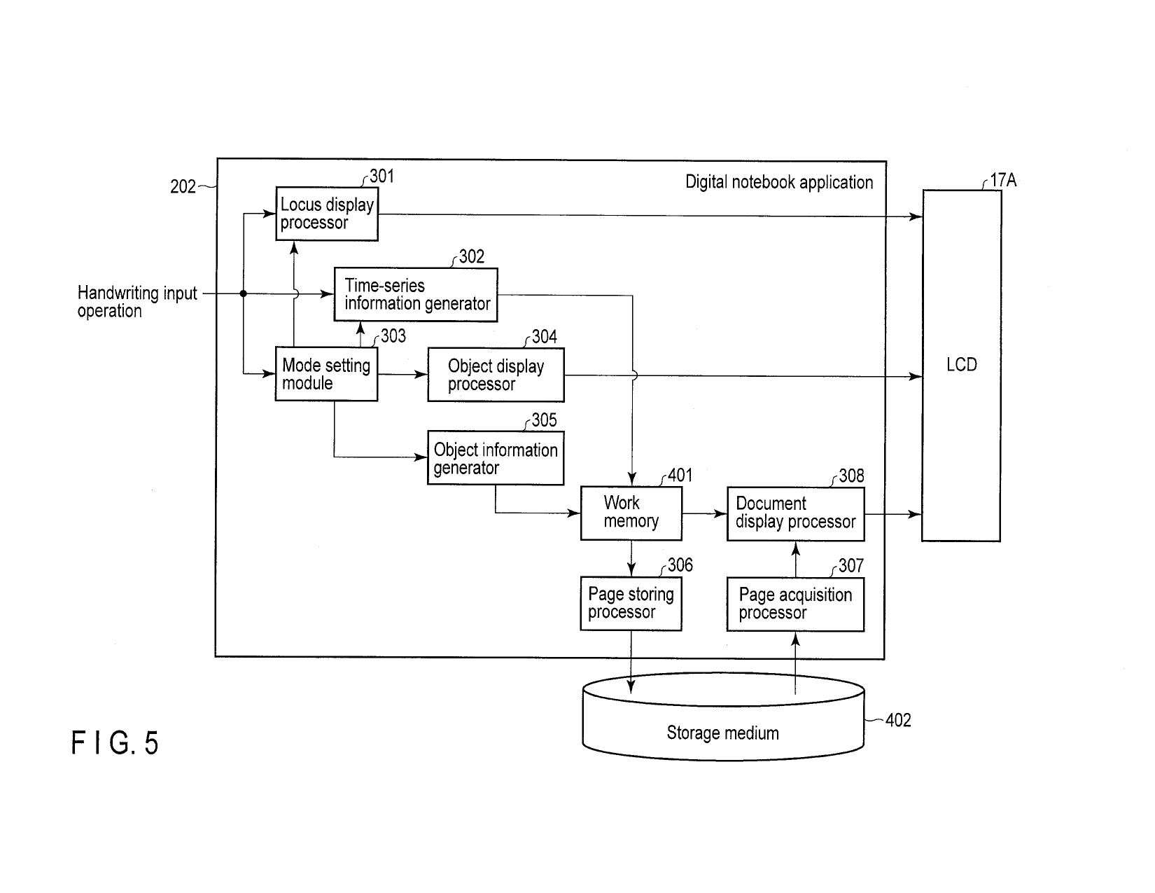

The functional configuration of the digital notebook application program 202 will be described below with reference to FIG. 5. The digital notebook application program 202 executes creation, displaying, editing, and the like of a handwritten document using stroke data input by handwriting input operation using the touch screen display 17.

The digital notebook application 202 (computer 10) is set in, for example, either the first mode or the second mode. The first mode is a free drawing mode for drawing a locus (stroke) corresponding to a handwriting input operation. The second mode is an arbitrary mode. For example, a mode for drawing a figure object (a figure of one type of a line, circle, rectangle, and the like), an “eraser” mode for erasing a locus displayed on a handwritten document, or the like is assigned to the second mode.

The digital notebook application program 202 includes, for example, a locus display processor 301, a time-series information generator 302, a mode setting module 303, an object display processor 304, an object information generator 305, a page storing processor 306, a page acquisition processor 307, a document display processor 308, and the like.

The touch screen display 17 is configured to generate events “touch”, “move (slide)”, “release”, and the like. The “touch” event indicates that the external object touched on the screen. The “move (slide)” event indicates that a touch position was moved while the external object touched on the screen. The “release” event indicates that the external object was released from the screen.

The locus display processor 301, time-series information generator 302, and mode setting module 303 receive the “touch”, “move (slide)”, or “release” event generated by the touch screen display 17, thereby detecting a handwriting input operation. The “touch” event includes coordinates of a touch position. The “move (slide)” event includes coordinates of a touch position of a move destination. The “release” event includes coordinates of a position (release position) where the contact position is released from the screen. Therefore, the locus display processor 301, time-series information generator 302, and mode setting module 303 can receive a coordinate sequence corresponding to a locus of a movement of a touch position from the touch screen display 17.

When the digital notebook application 202 (computer 10) is set in the first mode, the locus display processor 301 receives a coordinate sequence from the touch screen display 17. The locus display processor then displays, on the screen of the LCD 17A in the touch screen display 17, a locus of each stroke handwritten by a handwriting input operation using the pen 100 or the like based on this coordinate sequence. This locus display processor 301 draws a locus of the pen 100 while the pen 100 touches on the screen, that is, that of each stroke on the screen of the LCD 17A. For example, when a first stroke is input on the screen by handwriting and the digital notebook application 202 is in the first mode, the locus display processor 301 displays a locus corresponding to the first stroke on the screen.

The mode setting module 303 receives a coordinate sequence from the touch screen display 17, and sets the mode of the digital notebook application 202 (computer 10) based on this coordinate sequence. The mode setting module 303 determines, using the coordinate sequence, whether a period for which the position of the handwriting input is included in a first range is longer than a first period. The first range is, for example, a range within several pixels from the start position of the handwriting input. In addition, the first period is, for example, 0.5 seconds. If a period for which the position of the handwriting input is included in the first range is longer than the first period, the mode setting module 303 sets the digital notebook application 202 in the second mode (that is, the module 303 switches from the first mode to the second mode). Otherwise (for example, if the position of the handwriting input moves to fall outside the first range as soon as the handwriting input operation of a stroke is started), the mode setting module 303 remains setting the digital notebook application 202 in the first mode.

For example, a case will be described below wherein the mode setting module 303 sequentially receives coordinates corresponding to a first stroke which is being handwriting-input in turn from a first coordinate position (“touched” position on the screen).

In this case, if the handwriting input operation of the first stroke is continuously made for the first period or longer, the mode setting module 303 determines whether a plurality of pairs of received coordinates are included in the first range (for example, the range of several pixels to have the first coordinate position as the center). For example, if coordinates corresponding to the first stroke are continuously received for the first period or longer, the mode setting module 303 determines whether a plurality of pairs of received coordinates are included in the first range. If the plurality of pairs of received coordinates are included in the first range, the mode setting module 303 sets the digital notebook application 202 in the second mode. On the other hand, if the plurality of pairs of received coordinates are not included in the first range, the mode setting module 303 remains setting the digital notebook application 202 in the first mode.

Note that when the handwriting input operation of the first stroke ends for less than the first period, it is assumed that the first stroke is a very short stroke like “.” (period). In this case as well, the mode setting module 303 remains setting the digital notebook application 202 in the first mode.

The mode setting module 303 notifies the locus display processor 301, time-series information generator 302, object display processor 304, and object information generator 305 of the change from the first mode to the second mode.

In response to the mode change from the first mode to the second mode of the digital notebook application 202 (computer 10) while a first stroke is being handwriting-input on the screen, the locus display processor 301 erases the locus of the first stroke which is being drawn from the screen.

When the digital notebook application 202 is in the second mode while the first stroke is being handwriting-input on the screen, the object display processor 304 and object information generator 305 execute the first processing based on the first stroke. The object display processor 304 and object information generator 305 execute the first processing based on the first stroke in response to, for example, the mode change from the first mode to the second mode of the digital notebook application 202. To this first processing, for example, any of processing required to display a figure object (for example, a line, circle, or rectangle) corresponding to the first stroke on the screen, processing required to erase a locus of the first stroke from loci of strokes displayed on the screen, and processing required to display grids having predetermined intervals, and to display a line on grids based on the first stroke is assigned. In other words, to the second mode, any of a line drawing mode for drawing a line corresponding to the first stroke, a circle drawing mode for drawing a circle corresponding to the first stroke, a rectangle drawing mode for drawing a rectangle corresponding to the first stroke, an “eraser” mode for erasing a locus of the first stroke, and a grid mode for drawing a line on grids based on the first stroke is assigned. The mode (processing) to be assigned to the second mode is designated by, for example, the user.

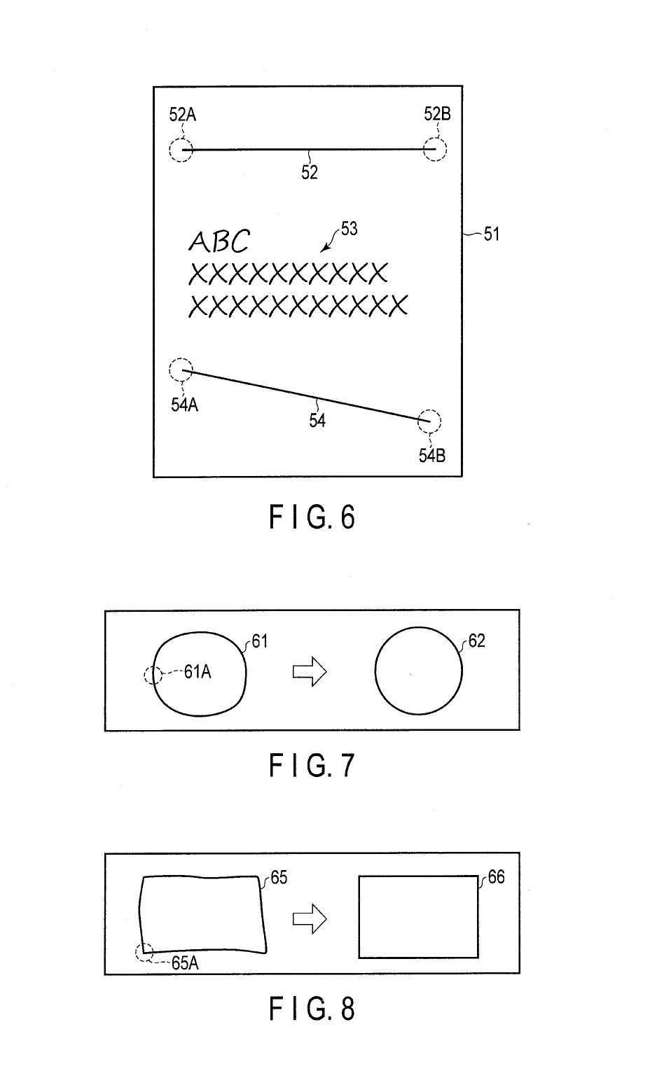

The respective modes assigned to the second mode will be described below with reference to FIGS. 6, 7, 8, 9, and 10.

FIG. 6 shows a drawing example of a line figure object on a handwritten document 51 when the line drawing mode is assigned to the second mode.

The user brings the external object (e.g., the finger or pen 100) into contact with a touch position (first position) 52A on the screen of the touch screen display 17 on which the handwritten document 51 is displayed. Then, the user stops the external object to fall within the first range including the touch position 52A for a threshold period (first period) or longer. In response to this, the mode setting module 303 controls the digital notebook application 202 (computer 10) to transit from the first mode to the line drawing mode assigned to the second mode.

Then, the user slides the external object without releasing it from the screen, and releases the external object at a release position 52B. In response to a release event of the external object from the screen, the object display processor 304 and object information generator 305 generate a line figure object 52, and the mode setting module 303 returns the digital notebook application 202 (computer 10) to the first mode. The object display processor 304 draws, for example, the line object 52 which connects the touch position 52A and release position 52B on the handwritten document 51. The object information generator 305 generates figure object data indicative of the drawn line object 52. This figure object data will be described later with reference to FIG. 11.

Note that the object display processor 304 may display a temporary line that connects the touch position 52A and a current contact position of the slide operation while the external object is being slide on the screen. Thus, the user can adjust the contact position by the slide operation while confirming the length, angle, and the like of the line.

Next, the user handwrites characters 53 and a figure on the handwritten document 51 by touch, slide, and release operations of the external object on the screen. That is, the locus display processor 301 displays loci (strokes) corresponding to the movements of the external object according to user operations, thus drawing the handwritten characters 53 and figure on the handwritten document 51.

Furthermore, in the same manner as in the aforementioned line 52, the user brings the external object into contact with a touch position (first position) 54A on the screen of the touch screen display 17 on which the handwritten document 51 is displayed, and stops the external object at that touch position 54A for the first period or longer. In response to this, the mode setting module 303 controls the digital notebook application 202 (computer 10) to transit from the first mode to the second mode.

Then, the user slides the external object without releasing it from the screen, and releases the external object at a release position 54B. In response to a release event of the external object from the screen, the object display processor 304 and object information generator 305 generate a line figure object 54, and the mode setting module 303 returns the digital notebook application 202 (computer 10) to the first mode. The object display processor 304 draws, for example, the line object 54 which connects the touch position 54A and release position 54B on the handwritten document 51. The object display processor 304 may display a temporary line object which connects the touch position 54A and the current contact position of the slide operation while the external object is being slide on the screen. The object information generator 305 generates figure object data indicative of the drawn line object 54.

FIG. 7 shows a drawing example of a circle figure object on a handwritten document when the circle drawing mode is assigned to the second mode.

The user brings the external object (for example, the finger or pen 100) into contact with a touch position (first position) 61A on the screen of the touch screen display 17 on which the handwritten document is displayed, and stops the external object at that touch position 61A for the first period or longer. In response to this, the mode setting module 303 controls the digital notebook application 202 (computer 10) to transit from the first mode to the circle drawing mode assigned to the second mode.

Then, the user inputs a handwritten circle 61 by sliding the external object without releasing it from the screen, and then releases the external object. In response to a release event of the external object from the screen, the object display processor 304 and object information generator 305 generate a circle figure object 62 corresponding to the handwritten circle 61, and the mode setting module 303 returns the digital notebook application 202 (computer 10) to the first mode. The object display processor 304 displays the circle object 62 corresponding to the handwritten circle 61 on the screen. The object information generator 305 generates figure object data indicative of the drawn circle object 62.

FIG. 8 shows a drawing example of a rectangle figure object on the handwritten document 51 when the rectangle drawing mode is assigned to the second mode.

The user brings the external object (for example, the finger or pen 100) into contact with a touch position (first position) 65A on the screen of the touch screen display 17 on which the handwritten document is displayed, and stops the external object at that touch position 65A for the first period or longer. In response to this, the mode setting module 303 controls the digital notebook application 202 (computer 10) to transit from the first mode to the rectangle drawing mode assigned to the second mode.

Then, the user inputs a handwritten rectangle 65 by sliding the external object without releasing it from the screen, and then releases the external object. In response to a release event of the external object from the screen, the object display processor 304 and object information generator 305 generate a rectangle figure object 66 corresponding to the handwritten rectangle 65, and the mode setting module 303 returns the digital notebook application 202 (computer 10) to the first mode. The object display processor 304 displays the rectangle object 66 corresponding to the handwritten rectangle 65 on the screen. The object information generator 305 generates figure object data indicative of the drawn rectangle object 66.

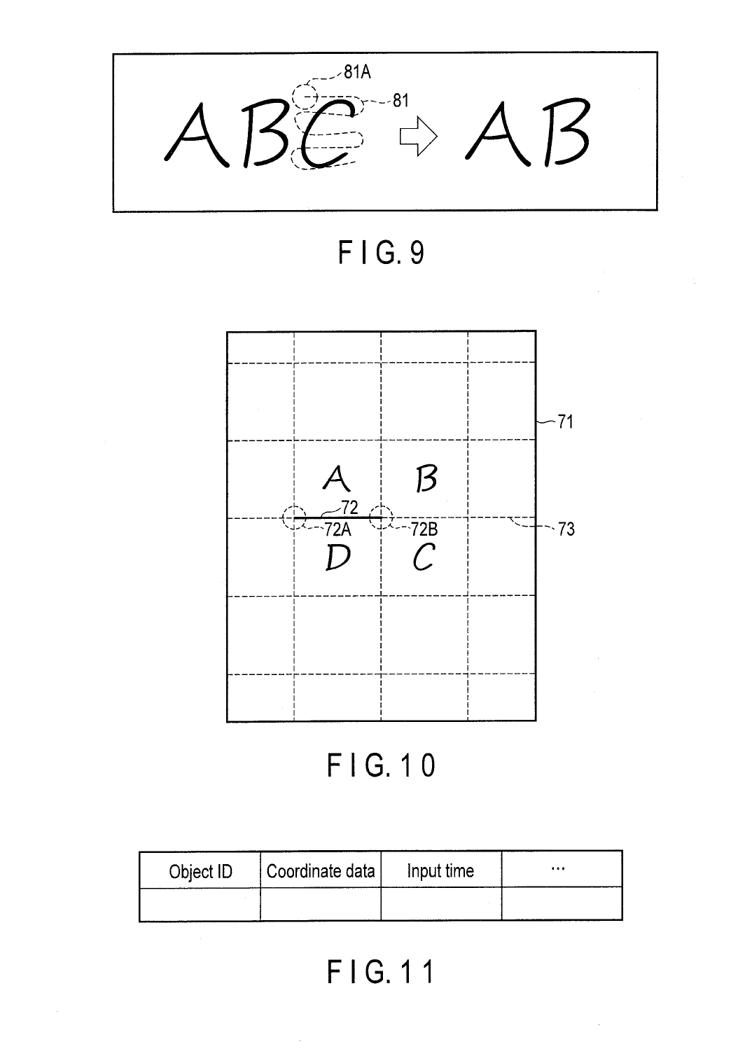

FIG. 9 shows an erasure example of descriptions (stroke) drawn on the handwritten document when the “eraser” mode is assigned to the second mode.

The user brings the external object (for example, the finger or pen 100) into contact with a touch position (first position) 81A on the screen of the touch screen display 17 on which the handwritten document is displayed, and stops the external object at that touch position 81A for the first period or longer. In response to this, the mode setting module 303 controls the digital notebook application 202 (computer 10) to transit from the first mode to the “eraser” mode assigned to the second mode.

Then, the user inputs a stroke 81 required to instruct a region to be erased by sliding the external object without releasing it from the screen, and then releases the external object from the screen. The locus display processor 301 erases a locus (a handwritten character “C” in this case) or figure object drawn on the region corresponding to the stroke 81 in real-time according to the input of the stroke 81. In this “eraser” mode, for example, a predetermined range having the stroke 81 as the center is erased. That is, the handwritten character “C” is erased since an “eraser” having a predetermined size is moved according to the stroke 81. In response to a release event of the external object from the screen, the mode setting module 303 returns the digital notebook application 202 (computer 10) to the first mode. Note that the time-series information generator 302 deletes stroke data corresponding to the erased locus (stroke) from the time-series information, or adds an operation history indicating that the stroke is deleted to the time-series information. Likewise, the object information generator 305 deletes figure object corresponding to the erased figure object, or adds an operation history indicating that the figure object is deleted to the figure object data.

FIG. 10 shows a drawing example of a line along a grid on a handwritten document when the grid mode is assigned to the second mode.

The user brings the external object into contact with a touch position (first position) 72A on the screen of the touch screen display 17 on which a handwritten document 71 is displayed, and stops the external object at that touch position 72A for the first period or longer. In response to this, the mode setting module 303 controls the digital notebook application 202 (computer 10) to transit from the first mode to the grid mode assigned to the second mode, and the object display processor 304 displays grid lines 73 (for example, dotted lines) having intervals on the handwritten document 71. The interval of the grid lines 73 is a prescribed interval, an interval designated by the user, an interval which is decided based on one or more strokes handwritten on the handwritten document 71, or the like.

The user slides the external object without releasing it from the screen, and releases the external object from a release position (end point) 72B from the screen. In response to a release event of the external object from the screen, the object display processor 304 and object information generator 305 generate a line figure object 72 on the grid 73 based on an input stroke (touch position and release position). Then, the mode setting module 303 returns the digital notebook application 202 (computer 10) to the first mode. Note that the grid lines 73 are not limited to those including horizontal and vertical lines, but they can be horizontal lines, vertical lines, diagonal lines, lines of arbitrary angles, and every combinations of them.

It is difficult for the user to perform the external object operation for designating of, for example, an accurate horizontal or vertical line. Even when the user wants to draw a horizontal or vertical line, a line that has a tilt of several degrees from the horizontal or vertical direction may be drawn. Using this grid mode, the user can easily instruct to draw a horizontal or vertical line indicated by the grids 73.

FIG. 11 shows an example of the configuration of the aforementioned figure object information.

The figure object information includes a plurality of entries corresponding to a plurality of figure objects. Each entry includes, for example, an object ID, coordinate data, and input time. In an entry corresponding to a certain figure object, “object ID” indicates identification information assigned to that figure object. “Coordinate data” indicates coordinates which express a shape of that figure object. “Time” indicates an input time (date and time) of that figure object.

For example, when a figure object is a line, “coordinate data” includes coordinates (X and Y coordinates) of two ends of the line. On the other hand, for example, when a figure object is a rectangle, “coordinate data” includes coordinates of four vertices that define the rectangle.

Note that when a figure object is a circle, its entry may further include “size”. In this case, “coordinate data” includes coordinates of a center of the circle, and “size” indicates a size (for example, a radius) of the circle.

With the above configuration, in each mode assigned to the second mode, the first processing based on the first stroke is executed. Also, as described above, when the digital notebook application 202 (computer 10) is set in the second mode, the mode setting module 303 sets the application 202 in the first mode (that is, the module 303 returns the application 202 from the second mode to the first mode) in response to completion of the handwriting input of the first stroke. Therefore, the digital notebook application 202 returns to the first mode without any user operations after completion of execution of the first processing based on the first stroke. Therefore, after the user makes an operation for inputting the first stroke required to execute the first processing in the second mode, he or she can immediately restart an operation for inputting a handwritten character or figure.

Note that when a predetermined period has elapsed since completion of the handwriting input of the first stroke, the mode setting module 303 may return the digital notebook application 202 to the first mode. Thus, the processing in the second mode can also be continued within the predetermined period since completion of the handwriting input of the first stroke.

In response to completion of the handwriting input of the first stroke when the digital notebook application 202 (computer 10) is in the first mode, the time-series information generator 302 generates time-series information (stroke data) having the structure described in detail using FIG. 3 based on a coordinate sequence of the first stroke output from the touch screen display 17. In this case, the time-series information, that is, coordinates corresponding to respective points of the stroke and time-stamp information may be temporarily stored in a work memory 401. Note that when the digital notebook application 202 is set in the second mode, the time-series information generator 302 does not generate any time-series information.

The page storing processor 306 stores the generated time-series information and figure object data (those which are temporarily stored in the work memory 401) in a storage medium 402 as handwritten document data. The storage medium 402 is, for example, a storage device in the tablet computer 10.

The page acquisition processor 307 reads arbitrary handwritten document data which has already been stored in the storage medium 402. The read handwritten document data is sent to the document display processor 308. The document display processor 308 analyzes the handwritten document data, and displays loci of respective strokes indicated by the time-series information and a figure object indicated by figure object data on the screen as a handwritten document (handwritten page) based on the analysis result.

With the aforementioned configuration, when the user handwrites characters or figures on a handwritten document (in the first mode), he or she can easily instruct to apply another processing (the first processing in the second mode) to the handwritten document.

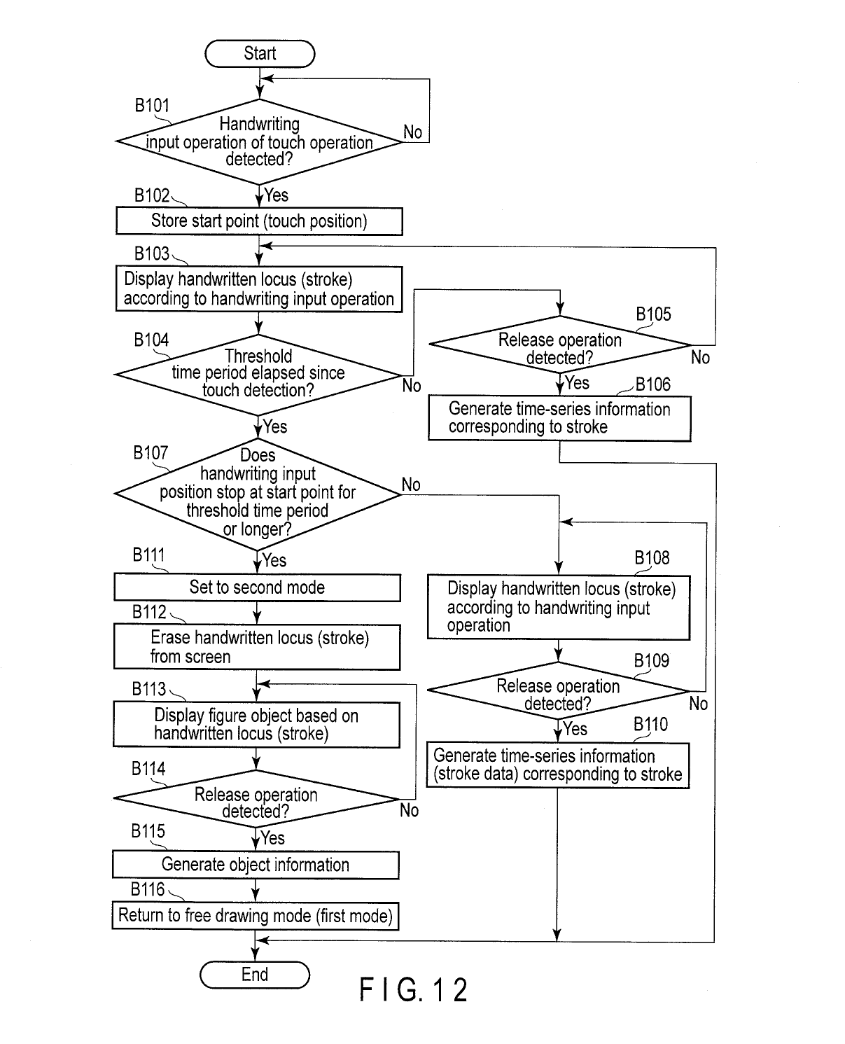

An example of the procedure of the handwriting input processing executed by the digital notebook application 202 will be described below with reference to FIG. 12. Note that the digital notebook application 202 (computer 10) is set in the first mode (free drawing mode) when this processing is started.

The mode setting module 303 determines whether a handwriting input operation as a “touch” operation is detected (block B101). For example, the mode setting module 303 determines whether an event indicating that the external object (for example, the finger or pen 100) is brought into contact with the screen of the touch screen display 17. If no “touch” operation is detected (NO in block B101), the process returns to block B101, and the mode setting module 303 determines again whether a “touch” operation is detected.

If a “touch” operation is detected (YES in block B101), the mode setting module 303 stores a start point (coordinates corresponding to a touch position) (block B102). Also, the locus display processor 301 displays a locus (stroke) of a movement of the pen 100 or the like by the handwriting input operation on the display 17A (block B103).

Next, the mode setting module 303 determines whether a threshold time period (first period) has elapsed since detection of the “touch” operation (block B104). If the threshold time period has not elapsed yet since detection of the “touch” operation (NO in block B104), the mode setting module 303 determines whether a “release” operation for releasing the external object from the screen is detected (block B105). If no “release” operation is detected (NO in block B105), the process returns to block B103 to continue to display the locus of the movement of the pen 100 or the like by the handwriting input operation.

If a “release” operation is detected (YES in block B105), the time-series information generator 302 generates the aforementioned time-series information (stroke data) based on a coordinate sequence corresponding to the locus (stroke) by the handwriting input operation (block B106), thus ending the processing. With the handwriting input operation, a time period from “touch” to “release” of which is less than the threshold time period, for example, a very short stroke such as “.” (a point like a period) is handwritten.

If the threshold time period has elapsed since detection of the “touch” operation (YES in block B104), the mode setting module 303 determines whether the handwriting input position stops at the start point (first position) for the threshold time period or longer (block B107). In other words, when the threshold time period has elapsed without releasing the external object from the screen after the external object is brought into contact (“touch”) with the screen, the mode setting module 303 determines whether the external object stops at the start point for the threshold time period or longer or it is moved from the start point. Note that the determination process may be that as to whether the external object (handwriting input position) is included within the first range (for example, the range of several pixels) including the start point for the threshold time period or longer.

If the handwriting input position does not stop at the start position for the threshold time period or longer (NO in block B107), the locus display processor 301 continues to display the locus of the movement of the pen 100 or the like by the handwriting input operation (block B108). Then, the time-series information generator 302 determines whether a “release” operation of releasing the external object from the screen is detected (block B109). If a “release” operation is detected (YES in block B109), the time-series information generator 302 generates the aforementioned time-series information (stroke data) based on a coordinate sequence corresponding to the locus (stroke) by the handwriting input operation (block B110). The time-series information generator 302 may temporarily store that time-series information in the work memory 401. If no “release” operation is detected (NO in block B109), the process returns to block B108 to continue to display the locus of the movement of the pen 100 or the like by the handwriting input operation.

If the handwriting input position stops at the start point for the threshold time period or longer (YES in block B107), the mode setting module 303 sets the digital notebook application 202 (computer 10) in the second mode (for example, the line drawing mode, circle drawing mode, rectangle drawing mode, “eraser” mode, or grid mode) (block B111). When the digital notebook application 202 is set in the second mode, the locus display processor 301 deletes a locus of a stroke, which is displayed on the screen (on the handwritten document) and is being handwriting-input, from the screen (block B112). Then, the object display processor 304 displays a figure object (for example, a line, circle, rectangle, or the like) based on the movement of the pen 100 or the like by the handwriting input operation (block B113). For example, when the second mode is the line drawing mode, the object display processor 304 displays a line which connects the start point and the current contact position by the handwriting input operation. Note that when the “eraser” mode is assigned to the second mode, a stroke or figure object which has already been handwritten on the handwritten document is erased based on the movement of the pen 100 or the like by the handwriting input operation.

Next, the object information generator 305 determines whether a “release” operation of releasing the external object from the screen is detected (block B114). If no “release” operation is detected (NO in block B114), the process returns to block B113 to continue to display a figure object (or to erase a stroke or figure object by “eraser”) based on the movement of the pen 100 or the like by the handwriting input operation.

If a “release” operation is detected (YES in block B114), the object information generator 305 generates object information (for example, object information indicative of start and end coordinates of a line) based on a coordinate sequence corresponding to the locus (stroke) by the handwriting input operation (block B115). The object information generator 305 may temporarily store that object information in the work memory 401. Then, the mode setting module 303 returns the digital notebook application 202 (computer 10) to the first mode (free drawing mode) (block B116).

As described above, according to this embodiment, the digital notebook application 202 can be easily switched from the first mode for inputting a handwritten character or figure to the second mode for executing the first processing. In addition, the digital notebook application 202 returns to the first mode without requiring any user operations after it displays a figure object based on one stroke in the second mode. Therefore, after the user makes an operation required to input one figure object, he or she can immediately restart an operation required to input a handwritten character or figure.

Note that the case has been exemplified wherein a handwriting input operation is made using the external object such as the finger or pen 100 on the touch screen display 17. The aforementioned processing is also applicable to a case in which a handwriting input operation is made using various pointing devices such as a mouse and touch pad.

As described above, according to this embodiment, when the user handwrites a character or figure on a handwritten document, he or she can easily instruct to execute another processing for that handwritten document. The mode setting module 303 sets the computer 10 in the second mode in response to an operation for temporarily stopping the external object (for the first period or longer) on the screen, and returns the computer 10 to the first mode in response to completion of the handwriting operation of that stroke. Thus, since the first and second modes can be switched by the handwriting input operation without requiring operations required to switch the mode using a button in a tool or menu, user efforts required to switch the mode can be reduced.

Note that all the process procedures of the handwriting input processing in this embodiment can be executed by software. Thus, the same effects as in this embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a processor configured to display, if a first stroke is handwriting-input on a screen and the electronic apparatus is in a first mode, a locus of the first stroke on the screen, and to execute, if the first stroke is handwriting-input on the screen and the electronic apparatus is in a second mode, first processing based on the first stroke; and
a setting module configured to set the electronic apparatus in the second mode if a period for which a position of a handwriting-input is in a first range is longer than a first period.

2. The apparatus of claim 1, wherein the setting module is configured to set, if the electronic apparatus is in the second mode, the electronic apparatus in the first mode in response to completion of an input of the first stroke.

3. The apparatus of claim 1, wherein the first processing comprises displaying a figure object corresponding to the first stroke on the screen.

4. The apparatus of claim 3, wherein the figure object is one of a line object, a circle object and a rectangle object.

5. The apparatus of claim 3, wherein the figure object is a line object which connects first coordinates and last coordinates of the first stroke.

6. The apparatus of claim 1, wherein the first processing comprises erasing a locus of the first stroke from loci of a plurality of strokes displayed on the screen.

7. The apparatus of claim 1, wherein the first processing comprises displaying grids having intervals and displaying a line on the grids based on the first stroke.

8. The apparatus of claim 1, wherein the processor is configured to erase a locus of the first stroke from the screen in response to setting of the second mode.

9. The apparatus of claim 1, further comprising a touch screen display,
wherein the first stroke is handwriting-input on the touch screen display.

10. A handwritten document processing method comprising:
displaying, if a first stroke is handwriting-input on a screen and an electronic apparatus is in a first mode, a locus of the first stroke on the screen;
setting the electronic apparatus in a second mode if a period for which a position of a handwriting-input is in a first range is longer than a first period; and
executing, if the first stroke is handwriting-input on the screen and the electronic apparatus is in the second mode, first processing based on the first stroke.

11. A computer-readable, non-transitory storage medium having stored thereon a program which is executable by a computer, the program controlling the computer to execute functions of:
displaying, if a first stroke is handwriting-input on a screen and the computer is in a first mode, a locus of the first stroke on the screen;
setting the computer in a second mode if a period for which a position of a handwriting-input is in a first range is longer than a first period; and
executing, if the first stroke is handwriting-input on the screen and the computer is in the second mode, first processing based on the first stroke.
